(19) United States
(12) Patent Application Publication
(10) Pub. No.: US 2018/0320391 A1
(43) Pub. Date: Nov. 8, 2018

(54) Panel Hoist

(71) Applicants: Joseph Eichhorn, Sr., Clarksville, OH (US); Dianne Eichhorn, Clarkesville, OH (US)

(72) Inventors: Joseph Eichhorn, Sr., Clarksville, OH (US); Dianne Eichhorn, Clarkesville, OH (US)

(21) Appl. No.: 15/589,991

(22) Filed: May 8, 2017

(51) Int. Cl. E04F 21/18

(52) U.S. Cl. CPC E04F 21/1894; E04F 21/1805; B66F 15/00; E04F 21/18; E04F 21/1822

(57) ABSTRACT

A lift assembly supports a pole at a desired position extending upwardly from a lift to facilitate supporting a panel at a desired position over the lift. The lift is configured to couple to a scaffold. The lift also is configured to selectively slidably couple to a pole. The pole is configured to slide upwardly relative to the lift to raise the pole to a desired position extending upwardly from the lift.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

[symbol]

### (2) Description of Related Art Including Information Disclosed Under 37 CFR 1.97 and 1.98

The disclosure and prior art relates to hoists and more particularly pertains to a new hoist for positioning panels, such as drywall sheets.

### BRIEF SUMMARY OF THE INVENTION

An embodiment of the disclosure meets the needs presented above by generally comprising a pair of lifts. Each lift is configured to couple to a respective opposing end of a scaffold. Each lift also is configured to selectively slidably couple to a respective T-shaped pole. The lifts are configured to couple to the T-shaped poles so that a panel, such as a sheet of drywall, is positionable upon the T-shaped poles. The T-shaped poles are configured to slide upwardly relative to the lifts to raise the panel to a desired position, such as adjacent to ceiling joists. Each lift is configured to couple to a respective T-shaped pole to retain the T-pole and the panel in the desired position. The lifts are configured to decouple from the T-shaped poles so that the T-shaped poles are configured to slide downwardly relative to the lifts.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a panel hoist according to an embodiment of the disclosure.

FIG. 2 is an isometric perspective view of an embodiment of the disclosure.

FIG. 3 is a side view of an embodiment of the disclosure.

FIG. 4 is a front view of an embodiment of the disclosure.

FIG. 5 is an in-use view of an embodiment of the disclosure.

### DETAILED DESCRIPTION OF THE INVENTION

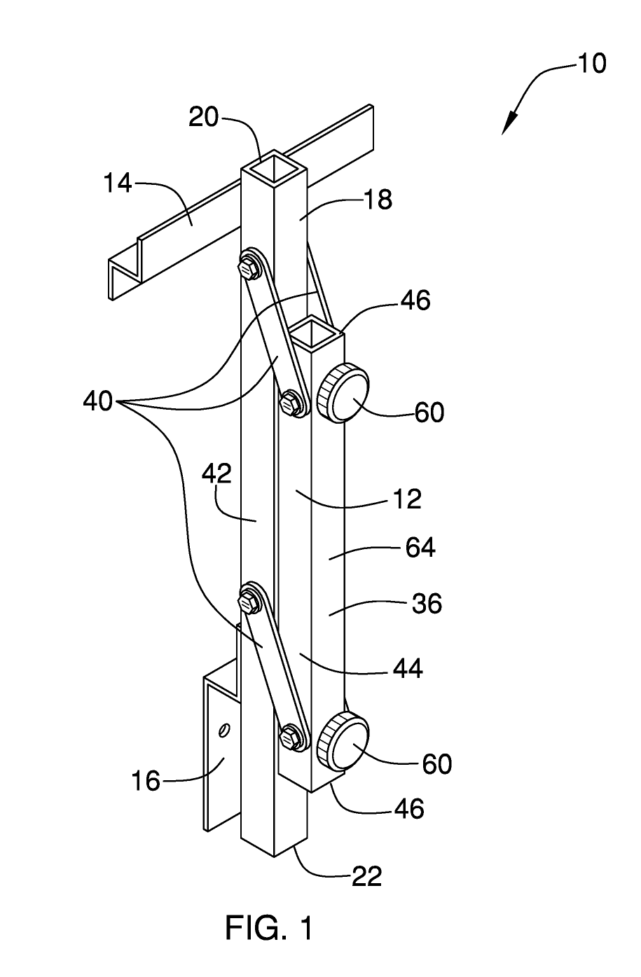

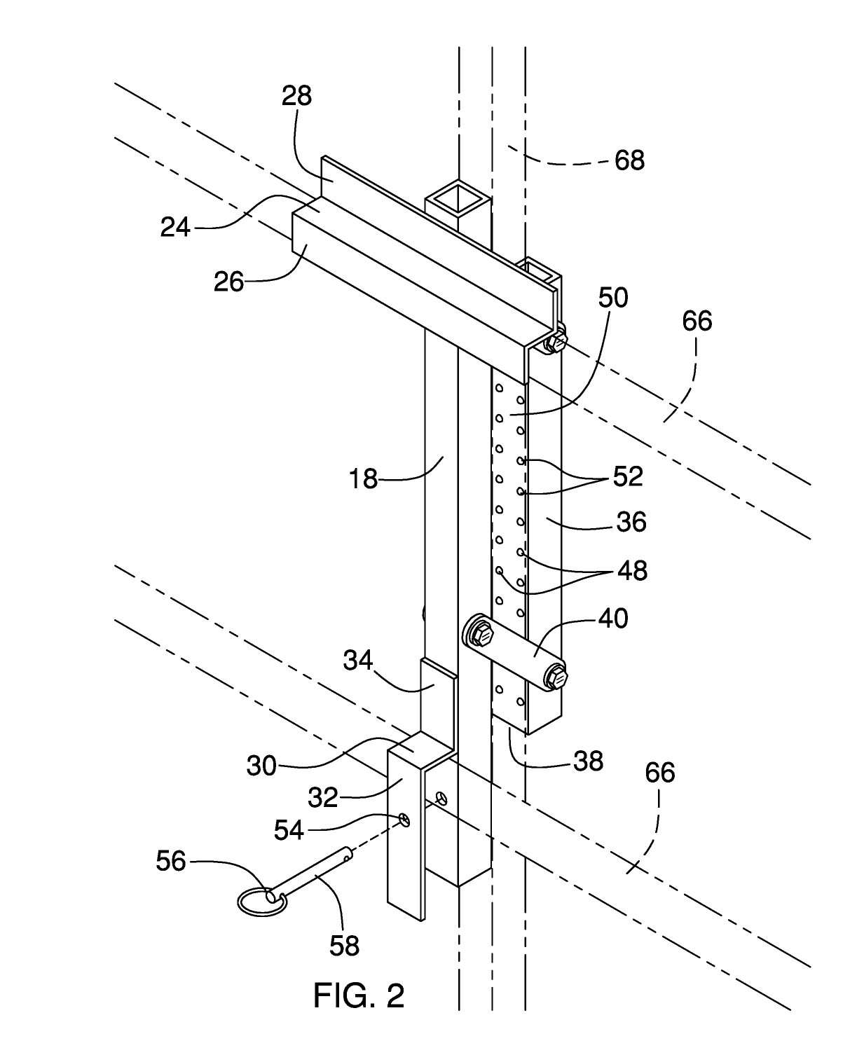

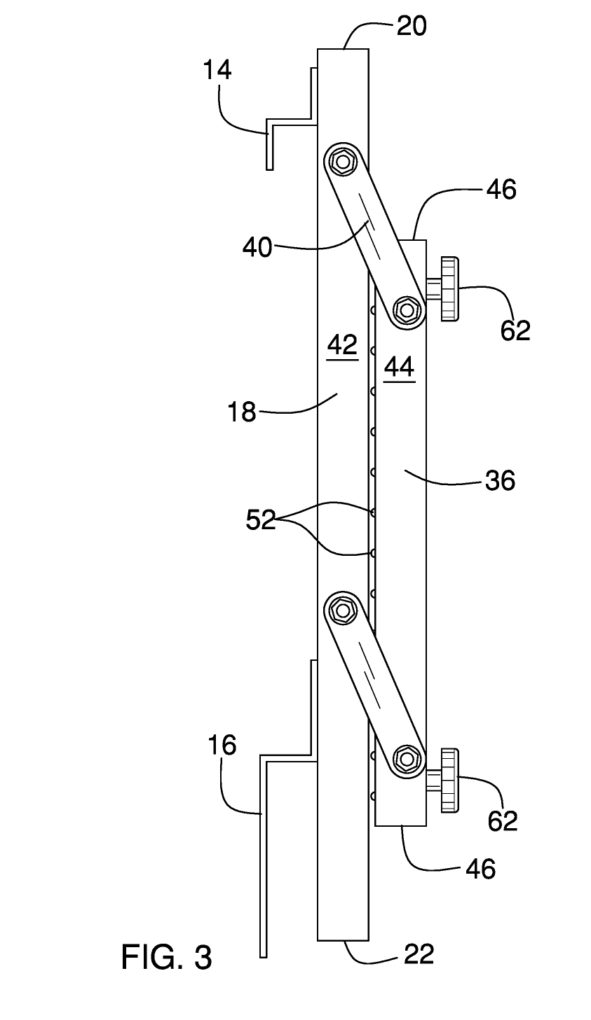

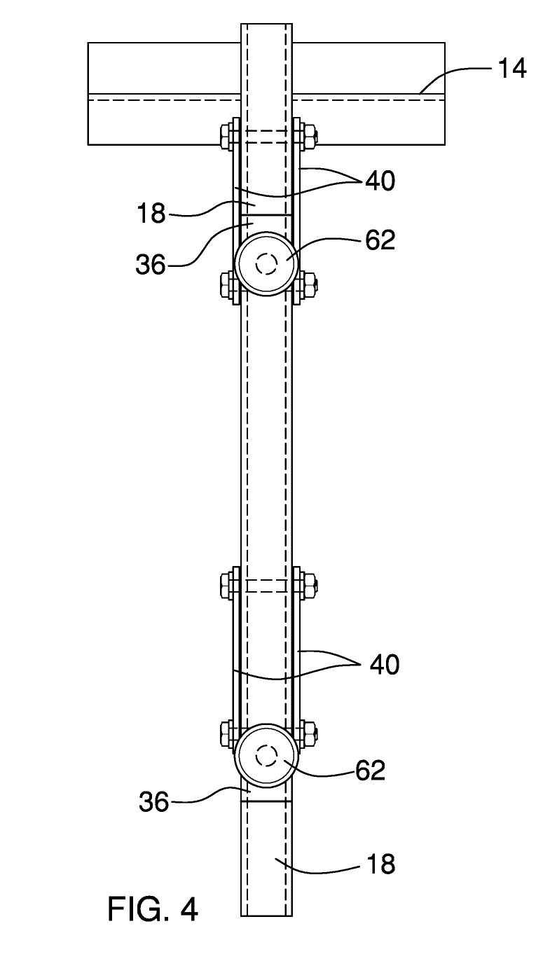

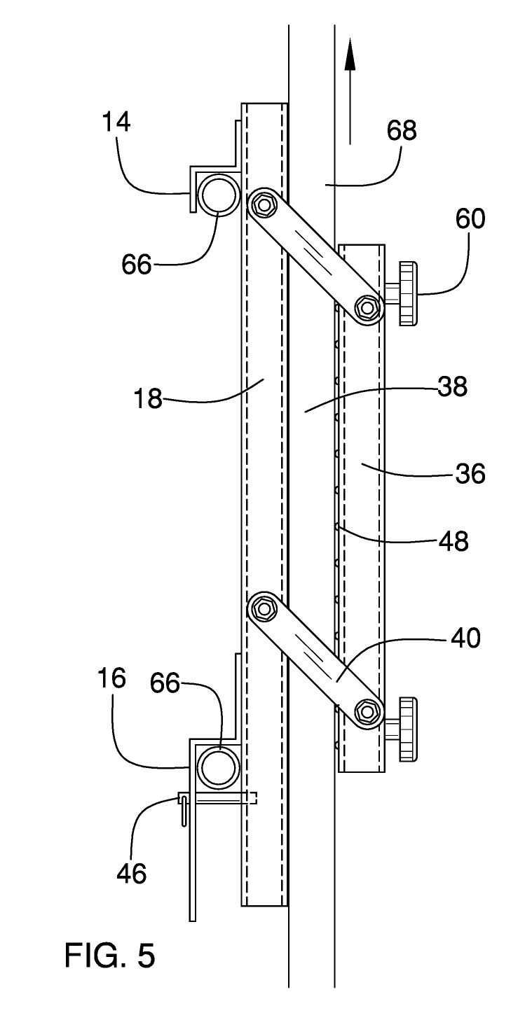

With reference now to the drawings, and in particular to FIGS. 1 through 5 thereof, a new hoist embodying the principles and concepts of an embodiment of the disclosure and generally designated by the reference numeral 10 will be described.

As best illustrated in FIGS. 1 through 5, the panel hoist 10 generally comprises a pair of lifts 12. Each lift 12 is configured to couple to a respective opposing end 46 of a scaffold. Each lift 12 also is configured to selectively slidably couple to a respective T-shaped pole. The lifts 12 are configured to couple to the T-shaped poles so that a panel, such as a sheet of drywall, is positionable upon the T-shaped poles. The T-shaped poles are configured to slide upwardly relative to the lifts 12 to raise the panel to a desired position, such as adjacent to ceiling joists. Each lift 12 is configured to couple to a respective T-shaped pole to retain the T-pole and the panel in the desired position. The lifts 12 are configured to decouple from the T-shaped poles so that the T-shaped poles are configured to slide downwardly relative to the lifts 12.

In one embodiment, each lift 12 comprises a first bracket 14 and a second bracket 16. The first bracket 14 and the second bracket 16 each are complementary to horizontal supports of the scaffold. A first tube 18 is coupled to and extends between the first bracket 14 and the second bracket 16. The first bracket 14 extends bidirectionally from the first tube 18 proximate to an upper end 20 of the first tube 18. The second bracket 16 extends from the first tube 18 proximate to a lower end 22 of the first tube 18. The first tube 18 is dimensioned so that the first bracket 14 and the second bracket 16 are configured to couple to adjacently positioned horizontal supports of the scaffold.

In one embodiment, the first bracket 14 comprises a first plate 24 and a second plate 26. The first plate 24 and the second plate 26 are substantially complementarily shaped. The first plate 24 is coupled to and extends perpendicularly from the first tube 18. The second plate 26 is coupled to and extends perpendicularly from the first plate 24 distal from the first tube 18. The second plate 26 extends toward the lower end 22 of the first tube 18. In another embodiment, a third plate 28 is coupled to the first tube 18 and the first plate 24. The third plate 28 and the first plate 24 are substantially complementarily shaped. The third plate 28 extends from the first plate 24 toward the upper end 20 of the first tube 18. The third plate 28 is positioned to stiffen the first plate 24.

In one embodiment, the second bracket 16 comprises a fourth plate 30 and a fifth plate 32. The fourth plate 30 is coupled to and extends perpendicularly from the first tube 18. The fifth plate 32 is coupled to and extends perpendicularly from the fourth plate 30 distal from the first tube 18. The fifth plate 32 extends toward the lower end 22 of the first tube 18. In another embodiment, a sixth plate 34 is coupled to the fourth plate 30 and the first tube 18. The sixth plate 34 extends from the fourth plate 30 toward the upper end 20 of the first tube 18.

A second tube 36 is pivotally coupled to and extendable from the first tube 18. The second tube 36 is selectively parallelly positionable relative to the first tube 18. The second tube 36 is configured to be grasped in at least one hand of a user to pivot the second tube 36 upwardly and outwardly from the first tube 18 to an extended position. In the extended position, the first tube 18 and the second tube 36 define a channel 38 that is complementary to a vertical member of the T-shaped pole. The channel 38 is configured to insert the vertical member to couple the T-shaped pole to the lift 12 and to position an upper member of the T-shaped pole substantially horizontally. In another embodiment, the first tube 18 and second tube 36 are squarely shaped when viewed longitudinally. In yet another embodiment, the second tube 36 is dimensionally shorter than the first tube 18.

Each of a plurality of straps 40, which is rigid, is pivotally coupled to and extends between the first tube 18 and the second tube 36 so that the second tube 36 is configured to pivot upwardly and outwardly from the first tube 18 to the extended position. In one embodiment, each strap 40 is positioned on a respective opposing side 42 of the first tube 18 and a respective opposing side face 44 of the second tube 36. In another embodiment, the plurality of straps 40 comprises four straps 40 that are positioned two-apiece proximate to opposing ends 46 of the second tube 36.

A grip 48 is coupled to an inside face 50 of the second tube 36. The grip 48 is configured to frictionally couple to the vertical member to couple the T-shaped pole to the lift 12. In one embodiment, the grip 48 comprises a plurality of teeth 52 that is evenly distributed between and linearly positioned proximate to the opposing side faces 44 of the second tube 36.

A hole 54 is positioned through the second bracket 16. The hole 54 is configured to insert coupling hardware 56, such as a pin 58, to secure the lift 12 to the scaffold.

A plurality of handles 60 is coupled to and extends from an outside face 64 of the second tube 36. The handles 60 are configured to be grasped in one or more hands of the user so that the second tube 36 is configured to be pivoted upwardly and outwardly from the first tube 18 to the extended position. In one embodiment, the plurality of handles 60 comprises two handles 60 that are positioned singly proximate to the opposing ends 46 of the second tube 36. In another embodiment, the handles 60 comprise knobs 62 that are circularly shaped and textured.

In use, the first brackets 14 and the second brackets 16 are positioned on the first tubes 18 such that each first bracket 14 and an associated second bracket 16 are configured to couple a respective lift 12 to adjacently positioned horizontal supports of the scaffold. The handles 60 that are positioned on the second tube 36 are configured to be grasped in the one or more hands of the user so that each second tube 36 is configured to be pivoted upwardly and outwardly from an associated first tube 18 to the extended position. The associated first tube 18 and the second tube 36 define a respective channel 38 that is complementary to the vertical member of a respective T-shaped pole. The respective channel 38 is configured to insert the vertical member to couple the respective T-shaped pole to the respective lift 12 with the upper member of the respective T-shaped pole substantially horizontally positioned. The panel, such as the sheet of drywall, is positionable upon the T-shaped poles. The T-shaped poles are configured to be slid upwardly through the channels 38. The panel is raised to the desired position, such as adjacent to the ceiling joists. The grips 48 that are positioned on the second tubes 36 are configured to frictionally couple to the vertical members to couple the T-shaped poles to the lifts 12 to retain the T-poles and the panel in the desired position. The grips 48 are configured to decouple from the T-shaped poles so that the T-shaped poles are configured to be slid downwardly in the channels 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A lift assembly comprising:
a lift, said lift being configured for coupling to a a pair of horizontal supports of a scaffold, said lift being configured for selectively slidably coupling to a pole; and
wherein said lift is configured for positioning on the scaffold such that said lifts are configured for coupling the pole in a raised position extending upwardly from the lift;
said lift comprising
a first bracket and a second bracket, said first bracket and said second bracket each being complementary to said horizontal supports of the scaffold;
a first tube coupled to and extending between said first bracket and said second bracket such that said first bracket extends bidirectionally from said first tube proximate to an upper end of said first tube and said second bracket extends from said first tube proximate to a lower end of said first tube;
a second tube pivotally coupled to and extendable from said first tube such that said second tube is selectively parallelly positionable relative to said first tube; and
wherein said second tube is positioned on said first tube such that said second tube is configured for grasping in at least one hand of a user for pivoting said second tube upwardly and outwardly from said first tube to an extended position wherein said first tube and said second tube define a channel complementary to the pole such that said channel is configured for coupling the pole to said lift; and
a grip coupled to an inside face of said second tube, wherein said grip is positioned on said second tube such that said grip is configured for frictionally coupling to the pole.

2. (canceled)

3. The assembly of claim 1, further including said first tube being dimensioned such that said first bracket and said second bracket are configured for coupling to adjacently positioned horizontal supports of the scaffold.

4. The assembly of claim 1, further including said first tube and said second tube being squarely shaped when viewed longitudinally.

5. The assembly of claim 1, further including said second tube being dimensionally shorter than said first tube.

6. The assembly of claim 1, further including a plurality of straps, said straps being rigid, each said strap being pivotally coupled to and extending between said first tube and said second tube, wherein said straps are positioned on said first tube and second tube such that said second tube is configured for pivoting upwardly and outwardly from said first tube to the extended position.

7. The assembly of claim 6, further including each said strap being positioned on a respective opposing side of said first tube and a respective opposing side face of said second tube.

8. The assembly of claim 7, further including said plurality of straps comprising four said straps positioned two-apiece proximate to opposing ends of said second tube.

9. (canceled)

10. The assembly of claim 1, further including said grip comprising a plurality of teeth evenly distributed between and linearly positioned proximate to opposing side faces of said second tube.

11. The assembly of claim 1, further including a hole positioned through said second bracket, wherein said hole is positioned in said second bracket such that said hole is configured for inserting coupling hardware for securing said lift to the horizontal supports of the scaffold.

12. The assembly of claim 1, further including a plurality of handles coupled to and extending from an outside face of said second tube, wherein said handles are positioned on said second tube such that said handles are configured for grasping in one or more hands of the user such that said second tube is configured for pivoting upwardly and outwardly from said first tube to the extended position.

13. The assembly of claim 12, further including said plurality of handles comprising two said handles positioned singly proximate to opposing ends of said second tube.

14. The assembly of claim 13, further including said handles comprising knobs, said knobs being circularly shaped, said knobs being textured.

15. The assembly of claim 1, further including said first bracket comprising a first plate and a second plate, said first plate and said second plate being substantially complementarily shaped, said first plate being coupled to and extending perpendicularly from said first tube, said second plate being coupled to and extending perpendicularly from said first plate distal from said first tube toward said lower end of said first tube.

16. The assembly of claim 15, further including a third plate coupled to said first tube and said first plate, said third plate and said first plate being substantially complementarily shaped, said third plate extending from said first plate toward said upper end of said first tube, wherein said third plate is positioned on said first plate and said first tube such that said third plate is positioned for stiffening said first plate.

17. The assembly of claim 1, further including said second bracket comprising a fourth plate and a fifth plate, said fourth plate being coupled to and extending perpendicularly from said first tube, said fifth plate being coupled to and extending perpendicularly from said fourth plate distal from said first tube toward said lower end of said first tube.

18. The assembly of claim 17, further including a sixth plate coupled to said fourth plate and said first tube, said sixth plate extending from said fourth plate toward said upper end of said first tube.

19. A lift assembly comprising:
a lift, said lift being configured for coupling to a a pair of horizontal supports of a scaffold, said lift being configured for selectively slidably coupling to a pole, wherein said lifts are configured for positioning on the scaffold such that said lifts are configured for coupling to the pole for sliding upwardly relative to said lift such that the pole is raised to a desired position extending upwardly from said lift, each said lift comprising:
a first bracket and a second bracket, said first bracket and said second bracket each being complementary to the horizontal supports of the scaffold,
a first tube coupled to and extending between said first bracket and said second bracket such that said first bracket extends bidirectionally from said first tube proximate to an upper end of said first tube and said second bracket extends from said first tube proximate to a lower end of said first tube, said first tube being dimensioned such that said first bracket and said second bracket are configured for coupling to adjacently positioned horizontal supports of the scaffold, said first tube being squarely shaped when viewed longitudinally, and
a second tube pivotally coupled to and extendable from said first tube such that said second tube is selectively parallelly positionable relative to said first tube, wherein said second tube is positioned on said first tube such that said second tube is configured for grasping in at least one hand of a user for pivoting said second tube upwardly and outwardly from said first tube to an extended position wherein said first tube and said second tube define a channel complementary to the pole such that said channel is configured for inserting the pole for coupling the pole to said lift, said second tube being squarely shaped when viewed longitudinally, said second tube being dimensionally shorter than said first tube,
a plurality of straps, said straps being rigid, each said strap being pivotally coupled to and extending between said first tube and said second tube, wherein said straps are positioned on said first tube and second tube such that said second tube is configured for pivoting upwardly and outwardly from said first tube to the extended position, each said strap being positioned on a respective opposing side of said first tube and a respective opposing side face of said second tube, said plurality of straps comprising four said straps positioned two-apiece proximate to opposing ends of said second tube,
a grip coupled to an inside face of said second tube, wherein said grip is positioned on said second tube such that said grip is configured for frictionally coupling to the pole for coupling the pole to said lift, said grip comprising a plurality of teeth evenly distributed between and linearly positioned proximate to said opposing side faces of said second tube,
a hole positioned through said second bracket, wherein said hole is positioned in said second bracket such that said hole is configured for inserting coupling hardware, such as a pin, for securing said lift to the horizontal supports of the scaffold,
a plurality of handles coupled to and extending from an outside face of said second tube, wherein said handles are positioned on said second tube such that said handles are configured for grasping in one or more hands of the user such that said second tube is configured for pivoting upwardly and outwardly from said first tube to the extended position, said plurality of handles comprising two said handles positioned singly proximate to said opposing ends of said second tube, said handles comprising knobs, said knobs being circularly shaped, said knobs being textured,
said first bracket comprising a first plate and a second plate, said first plate and said second plate being substantially complementarily shaped, said first plate being coupled to and extending perpendicularly from said first tube, said second plate being coupled to and extending perpendicularly from said first plate distal from said first tube toward said lower end of said first tube,
a third plate coupled to said first tube and said first plate, said third plate and said first plate being substantially complementarily shaped, said third plate extending from said first plate toward said upper end of said first tube, wherein said third plate is positioned on said first plate and said first tube such that said third plate is positioned for stiffening said first plate,
said second bracket comprising a fourth plate and a fifth plate, said fourth plate being coupled to and extending perpendicularly from said first tube, said fifth plate being coupled to and extending perpendicularly from said fourth plate distal from said first tube toward said lower end of said first tube, and
a sixth plate coupled to said fourth plate and said first tube, said sixth plate extending from said fourth plate toward said upper end of said first tube; and
wherein said first bracket and said second bracket are positioned on said first tube such that said first bracket and said second bracket are configured for coupling said lift to the horizontal supports of the scaffold, wherein said handles are positioned on said second tube such that said handles are configured for grasping in the one or more hands of the user such that said second tube is configured for pivoting upwardly and outwardly from said first tube to the extended position.
